(19) United States
(12) Patent Application Publication
(10) Pub. No.: US 2010/0016048 A1
(43) Pub. Date: Jan. 21, 2010

(54) GAME DEVICE FOR A SUBMARINE SIMULATOR

(75) Inventors: Cheng-Kuang Chu, Taipei County (TW); Chia-Hong Lin, Taipei County (TW); I-Fang Lu, Taipei County (TW); Yan-Wun Chen, Taipei County (TW)

Correspondence Address: ROSENBERG, KLEIN & LEE, 3458 ELLICOTT CENTER DRIVE-SUITE 101, ELLICOTT CITY, MD, 21043, US

(73) Assignee: INTERNATIONAL GAMES SYSTEM CO., LTD., Taipei County (TW)

(21) Appl. No.: 12/207,742

(22) Filed: Sep. 10, 2008

(30) Foreign Application Priority Data
Jul. 18, 2008 (TW) 097127304

(51) Int. Cl. A63F 9/24; A63F 13/00

(52) U.S. Cl. 463/5

(57) ABSTRACT

A game device includes a processor, a display device having a screen displaying a plurality of enemy vessel images, an invisible vessel image and a target-finding frame, and a joystick device. The enemy vessel images and the invisible vessel image are moving across the screen. The invisible vessel image is concealed in the screen. The joystick device controls movement of the target-finding frame in the screen. The processor is capable of transforming the invisible vessel image into a visible vessel image when the target-finding frame is moved to overlap the invisible vessel image. In case the enemy vessel images and the invisible vessel image are attacked, the processor executes in such a manner to blow the enemy vessel images and the invisible vessel image off the screen.

### FIELD OF THE INVENTION

The invention relates to a game device, more particularly to a game device for a submarine simulator.

### BACKGROUND OF THE INVENTION

Since rapid development in the game device, several types of simulation games are available in the market, such as car, airplane, or submarine simulators. A game device for a submarine simulator includes a screen for displaying a periscopic image moving and searching for an enemy vessel for firing a torpedo to hit the enemy vessel. Once the enemy vessel is hit, the player scores marks.

In the aforesaid game device, it is required to simulate movement of the torpedo. Since the moving speed of the torpedo is slower while compared with that of a laser or a rocket etc. such that the game to simulate attack on the enemy vessel fails to bring sufficient entertainment to the player. In other words, it is somewhat monotonous and does not attract attention of the player after playing a period of time.

### SUMMARY OF THE INVENTION

In view of the aforementioned facts, the prior art submarine simulator does not provide sufficient entertainment and is thus monotonous. Therefore, the object of the present invention is to provide a game device for the submarine simulator, in which an invisible vessel image is concealed in a screen in such a manner that the invisible vessel image is transformed into a visible vessel image when the target-finding frame is moved to overlap the invisible vessel image.

In order to achieve the aforesaid objectives, a game device is provided according to the present invention for a submarine simulator. The game device accordingly includes a processor for processing the submarine simulator, a display device having a screen displaying a plurality of enemy vessel images, an invisible vessel image and a target-finding frame, and a joystick device. The enemy vessel images and the invisible vessel image are moving across the screen. The invisible vessel image is concealed in the screen. The joystick device controls movement of the target-finding frame in the screen. When the target-finding frame is moved to overlap the invisible vessel image, the processor is capable of transforming the invisible vessel image into a visible vessel image. In case the enemy vessel images and the invisible vessel image are attacked, the processor destroys the enemy vessel images and the invisible vessel image.

In order to achieve the aforesaid objectives, a game method for the submarine simulator is provided. According to the present invention, a screen is used for displaying a plurality of enemy vessel images, at least one invisible vessel image and a target-finding frame. The enemy vessel images and the invisible vessel image are moving across the screen. The invisible vessel image is concealed in the screen. The game method comprises the steps of: transforming the invisible vessel image into a visible vessel image so as to be displayed by the screen when the target-finding frame overlaps the invisible vessel image; wherein, in case the enemy vessel images and the invisible vessel image are attacked, the enemy vessel images and the invisible vessel image are destroyed, thereby scoring marks.

By providing the present invention, when the target-finding frame is moved to overlap the invisible vessel image, the invisible vessel image is transformed into a visible vessel image so as to be displayed by the screen. Therefore, the player needs to find out the invisible vessel image by moving the target-finding frame. This action inspires the sporting spirit of the player, and thus the player does not feel monotonous even after a relatively long period of time.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 shows a block diagram representing elements of a game device of the present invention;

FIG. 2 is a perspective view of a joystick device employed in the game device of the present invention;

FIGS. 3 and 4 respectively show a screen of the game device of the present invention; and

FIG. 5 illustrates a block diagram representing the steps constituting the game method of the present invention.

### DETAILED DESCRIPTION OF THE PREFERRED EMBODIMENT

The game device of the present invention is used for a submarine simulator. The player must operate a virtual submarine and uses a periscope for searching an enemy vessel image. Once the enemy vessel image is found in the periscope, he/she can fire a torpedo to hit the enemy vessel image.

An invisible vessel image is added in the game device of the present invention. The player must use a joystick device to shift a target-finding frame from one place to another in such a manner to overlap the invisible vessel image, and only then the invisible vessel image can be transformed into a visible vessel image.

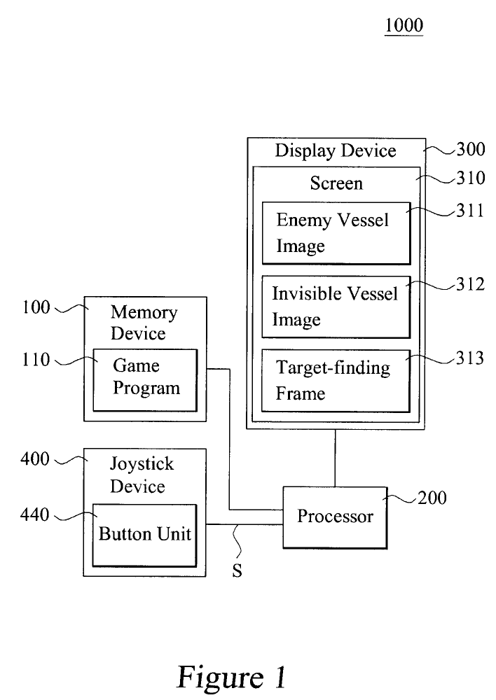

FIG. 1 shows a block diagram representing elements of a game device 1000 of the present invention. The game device 1000 can be a game machine or a computer set to executes a submarine simulator. The game device 1000 accordingly includes a memory unit 100, a processor 200, a display device 300 and a joystick device 400.

The memory unit 100 can be any mass storage device, like a memory device or a hard disk. A game program 110 is stored within the memory unit 100.

The processor 200 is coupled to the memory unit 100 for processing the game program 110 for executing the submarine simulator.

The display device 300 is coupled to the processor 200, and includes a screen 310 for displaying the submarine simulator. The screen 310 displays a plurality of enemy vessel images 311, at least one invisible vessel image 312 (shown in dotted lines) and a target-finding frame 313. The plural enemy vessel images 311 and the invisible vessel image 312 are moving across the screen 310. The invisible vessel image 312 is concealed in the screen 310 (shown by dotted lines).

The joystick device 400 is coupled to the processor 200. A manual of the joystick device 400 results in sending a control signal S to the processor 200 for undergoing a procession. The control signal S can be a fire command, a moving command or a specific attack command depending on controlling upon the joystick device 400.

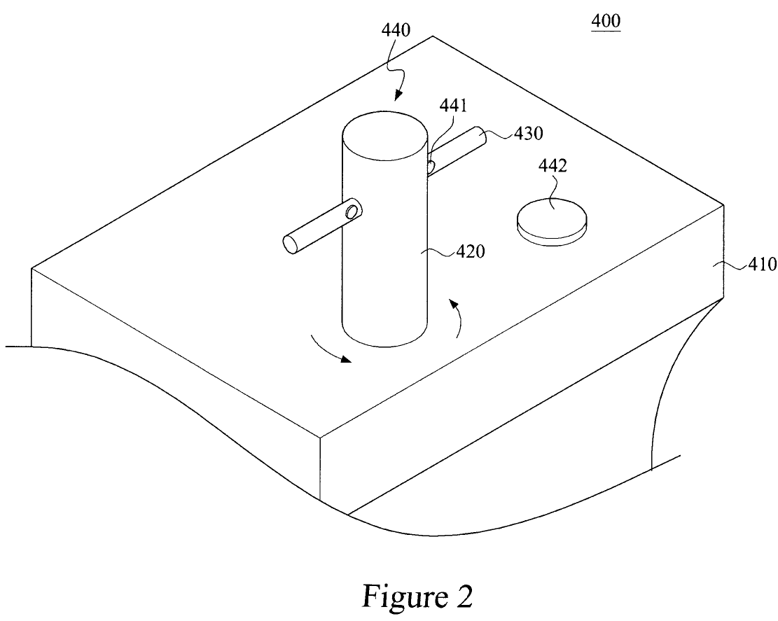

FIG. 2 is a perspective view of the joystick device 400 employed in the game device of the present invention. The joystick device 400 includes a bottom seat 410, a rotary lever 420 mounted pivotally on the bottom seat 410 so as to be rotated leftwise and rightwise directions thereof, a periscopic handle 430 extending transversely from a top end of the rotary lever 420 and a button unit 440. After gripping the periscopic handle 430, the player can rotate the rotary lever 420 in the leftwise and rightwise directions, thereby generating the moving command. The player can further turn the periscopic handle 430 to simulate movement of a submarine in the frontward and backward directions, emerges out from the water surface or submerges below the water surface and raising the target-finding frame above the sea level to search for enemy vessel image.

The button unit 440 includes a press button 441 mounted on the handle 430 and pressing of which results in the fire command, and an attack button 442 mounted on the rotary lever 420. Pressing of the attack button 442 results in the specific attack command.

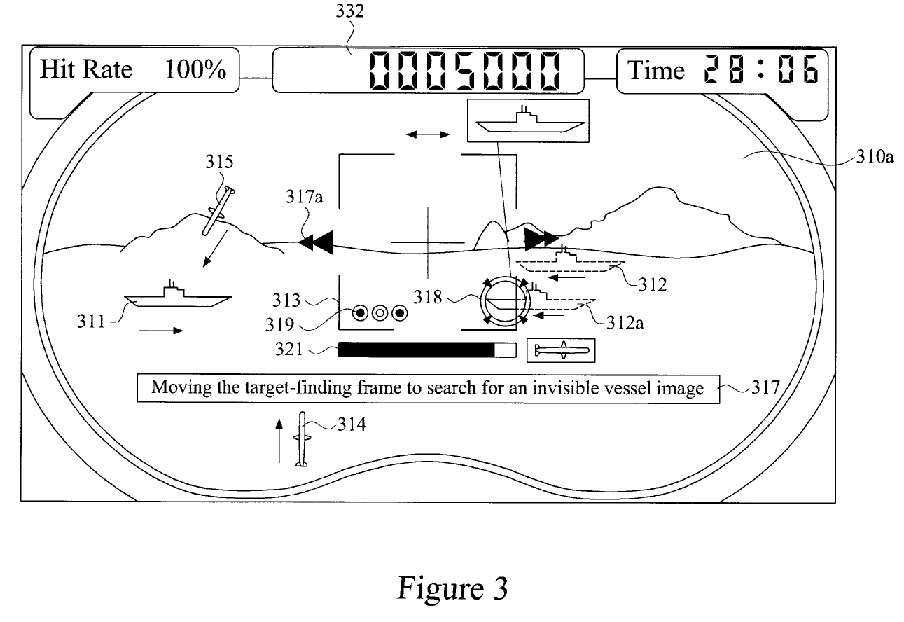

FIG. 3 shows the screen of the game device of the present invention for the submarine simulator. Please also see FIGS. 1 and 2, the player can operate the joystick device 400 in order to control movement of the target-finding frame 313 in the screen 310. When the target-finding frame 313 is moved to overlap the invisible vessel image 312 partially, the processor 200 is capable of transforming the invisible vessel image 312 into a visible vessel image. As shown in FIG. 3, a portion of the invisible vessel image 312 within the target-finding frame 313 is visible on the screen 310 since the portion is shown in solid lines

The aforesaid screen 310 further includes several alarm-generating elements 317, 317a that can generate alarm signals in case of detecting presence of the invisible vessel image 312 at the surrounding environment. The alarm-generating elements 317a can be fixed on two sides of the target-finding frame 313. Installation of the alarm-generating elements 317a can bring extra excitement to the player. The presence of alarm-generating elements suggests the player to conduct searching the target via moving the target-finding frame 313.

The aforesaid screen 310 further includes a target-fixing object 318 that is capable of overlapping one of the invisible vessel image 312 or one enemy vessel image 311 automatically when the target-finding frame 313 overlaps the invisible vessel image 312 or the enemy vessel image 311.

When the player presses the button 441, the fire command is generated and is transmitted to the processor 200 for further processing, thereby resulting in firing a torpedo image 314 from a near portion to a distal portion of the screen 310. The torpedo image 314 follows a direction indicated by the target-finding frame 313 so as to hit the enemy vessel image 311 and the invisible vessel image 312. In FIG. 3, a launch indicator 319 is provided to illustrate status of torpedo whether it is prepared for launching.

Since the torpedo image 314, the enemy vessel image 311 and the invisible vessel image 312 are moving in the screen 310 at different speeds, the player must estimate the cross timing of the torpedo image 314 with respective to the moving target so at to hit successfully the enemy vessel image 311 or the invisible vessel image 312. This action can challenge the player to encounter difficulties in the game device for the submarine simulator.

When the player presses the attack button 442, a specific fire command is resulted and is later processed by the processor 200 to control the screen 310, in which a missile image 315 is fired from the top portion of the screen 310 or any position toward the enemy vessel image 311 and/or the invisible vessel image 312. Since the enemy vessel image can be attacked by the missile image 315 anywhere within the screen 310, the player can press the attack button 442 arbitrarily whenever, he/she feels, he/she is in an emergency situation. This brings extra alteration of the game device of the present invention.

Of course, there should be limitation relative to pressing numbers of the attack button 442 to fire the missile image 315 so that the difficulty to hit the enemy vessel image is not reduced. In this embodiment, the missile launch indicator 321 indicates that if the missile image 315 can be fired.

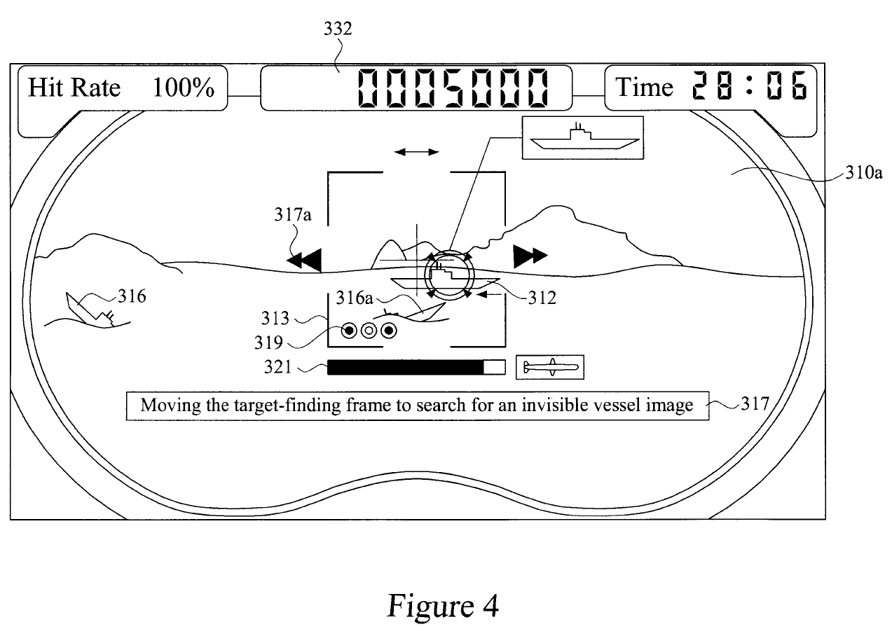

FIG. 4 shows the screen 310a replacing the screen 310 of FIG. 3 in the game device 1000 of the present invention after the player has played a period of time. The enemy vessel image 311 and the visible submarine image 312a of FIG. 3 within the target-finding frame 313 are being hit by the missile image 315 and the torpedo image 314 respectively. At this time, the processor 200 can destroy the enemy vessel image 311 and the visible vessel image 312a of FIG. 3 and replaced by the destroyed images 316, 316a shown in FIG. 4. A score table 332 is shown in the screen 310a to illustrate the marks scored by the player for hitting the enemy and invisible vessel images.

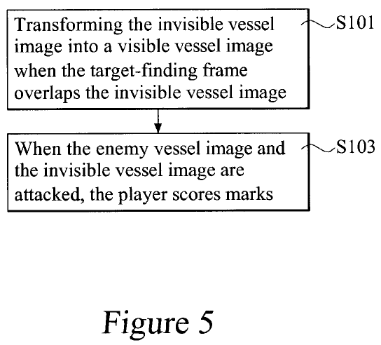

FIG. 5 illustrates a block diagram representing the steps constituting the game method of the present invention, wherein the elements and numerals employed herein are shown in FIGS. 1 to 4. The game device of the present invention is to simulate the submarine simulator within a screen 310. The screen 310 displays a plurality of enemy vessel images 311, at least one invisible vessel image 312 and a target-finding frame 313. The enemy vessel images 311 and the invisible vessel image 312 are moving across the screen 310. The invisible vessel image 312 is concealed in the screen 310. The game method includes the following steps.

Firstly, when the target-finding frame 313 overlaps the invisible vessel image 312, the invisible vessel image 312 is transformed into a visible vessel image so as to be displayed by the screen 310 such that the target-fixing object 318 can overlap the invisible vessel image 312 (step 101).

Secondly, a torpedo image 314 is fired from a near portion away to a distal portion of the screen 310 to hit the enemy vessel image 311 and the invisible vessel image 312 such that, in case the enemy vessel image 311 and the invisible vessel image 312 are hit, the scored marks of the player are shown within the score table 332 in the screen 310 (step 103).

By providing the present invention, since an invisible vessel image is added in the game device and only when the target-finding frame overlaps the invisible vessel image, the invisible vessel image is transformed into the visible vessel image and is displayed in the screen. Therefore, the player needs to find out the invisible vessel by moving the target-finding frame from one place to another. This action arouses the playing spirit of the player, which, in turn, cultivates the patience of the player for a longer playing time.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A game device for a submarine simulator, comprising:
a processor for processing the submarine simulator;
a display device including a screen for displaying the submarine simulator, said screen displaying a plurality of enemy vessel images, at least one invisible vessel image and a target-finding frame, said a plurality of enemy vessel images and said invisible vessel image moving across said screen, said invisible vessel image being concealed in said screen;
a joystick device for controlling movement of said target-finding frame in said screen, wherein said processor is capable of transforming said invisible vessel image into a visible vessel image when said target-finding frame is moved to overlap said invisible vessel image;
wherein, in case said enemy vessel images and said invisible vessel image are attacked and hit, said processor destroys said enemy vessel images and said invisible vessel image.

2. The game device according to claim 1, further comprising a press button to generate a fire command for firing a torpedo image from a near portion to a distal portion of said screen and toward a direction indicated by said target finding frame to hit said enemy vessel image and said invisible vessel image.

3. The game device according to claim 2, wherein said press button is mounted on said joystick device.

4. The game device according to claim 1, wherein said joystick device includes a periscope handle, activation of said periscope handle resulting in a leftwise-and-rightwise movement of said target-finding frame relative to said screen.

5. The game device according to claim 1, wherein said screen further displays a target-fixing object that is capable of overlapping said invisible vessel image when said target-finding frame overlaps said invisible vessel image.

6. A game method for submarine simulator, wherein a screen is used for displaying a plurality of enemy vessel image, at least one invisible vessel image and a target-finding frame, the enemy vessel images and the invisible vessel image moving across the screen, the invisible vessel image being concealed in the screen, the game method comprising the steps of:
(1) transforming the invisible vessel image into a visible vessel image so as to be displayed by the screen when the target-finding frame overlaps said invisible vessel image;
wherein, in case said enemy vessel images and said invisible vessel image are hit, said enemy vessel images and said invisible vessel image are destroyed, thereby scoring marks.

7. The game method according to claim 6, further comprising a step of displaying a target-fixing object in the screen, said target-fixing object capable of overlapping said invisible vessel image when said target-finding frame overlaps said invisible vessel image.

8. The game method according to claim 6, further comprising a step of firing a torpedo image from a near portion to a distal portion of the screen toward a direction indicated by the target-finding frame to hit the enemy vessel image and the invisible vessel image.
